(19) United States
(12) Patent Application Publication
(10) Pub. No.: US 2026/0145390 A1
(43) Pub. Date: May 28, 2026

(54) MEASUREMENT METHOD OF THREE DIMENSIONAL MOLDING DEVICE

(71) Applicant: SEIKO EPSON CORPORATION, Tokyo (JP)

(72) Inventor: Masaaki KINOSHITA, SHIOJIRI-SHI (JP)

(21) Appl. No.: 19/399,822

(22) Filed: Nov. 25, 2025

(30) Foreign Application Priority Data
Nov. 28, 2024 (JP) 2024-207070

(51) Int. Cl. B29C 64/393; B29C 64/209; B29C 64/35; B33Y 30/00; B33Y 40/00; B33Y 50/02; G01L 7/16; G01L 27/00

(52) U.S. Cl. CPC B29C 64/393; B29C 64/209; B29C 64/35; B33Y 30/00; B33Y 40/00; B33Y 50/02; G01L 7/16; G01L 27/00

(57) ABSTRACT

A measurement method of a three dimensional molding device, the three dimensional molding device including the first pressure measurement step of measuring the pressure of the pressure generating section 500 as first pressure data; a second pressure measurement step of measuring, by the measurement section 240, a pressure generated by the pressure generating section 500 biasing the plunger pin as second pressure data; and a third pressure measurement step of measuring a difference between the first pressure data and the second pressure data.

The present application is based on, and claims priority from JP Application Serial Number 2024-207070, filed Nov. 28, 2024, the disclosure of which is hereby incorporated by reference herein in its entirety.

### BACKGROUND

### 1. Technical Field

The present disclosure relates to a measurement method of a three dimensional molding device.

### 2. Related Art

JP-A-2023-3588 discloses a three dimensional molding device in which an injection plunger is slid in an injection cylinder to inject a plasticization material in the injection cylinder into a mold through a nozzle. The flow rate of the plasticization material is controlled based on a detection value of a pressure detection section that detects the pressure of the plasticization material. When plasticization material accumulates and becomes fixed in the injection cylinder, the flow rate changes, and thus it is necessary to periodically perform maintenance.

However, in the configuration described in JP-A-2023-3588, there is a problem that it is difficult to confirm whether the pressure detection section can detect an accurate detection value after maintenance is performed.

### SUMMARY

A measurement method of a three dimensional molding device, the three dimensional molding device including a flow path through which a plasticization material plasticized by heat flows; a nozzle communicating with the flow path and configured to deliver the plasticization material outside; a pressure detection section that detects pressure of at least a part of the flow path; and a pressure generating section connected to the pressure detection section and configured to generate pressure, wherein the pressure detection section includes a cylinder connected to the flow path, a plunger pin slidably disposed in the cylinder,

a transmission member connected to an opposite side of the plunger pin than the flow path, and a measuring section that is connected via the transmission member and measures a pressure received by the plunger pin from the plasticization material, the method including a first pressure measurement step of measuring pressure of the pressure generating section as first pressure data; a second pressure measurement step of the measuring section measuring, as second pressure data, pressure generated by the pressure generating section biasing the plunger pin; and a third pressure measurement step of measuring a difference between the first pressure data and the second pressure data.

### BRIEF DESCRIPTION OF THE DRAWINGS

FIG. 1 is a schematic view illustrating a configuration of a three dimensional molding device.

FIG. 2 is a perspective view illustrating a configuration of a groove forming surface side of a screw.

FIG. 3 is a plan view illustrating a configuration of a barrel on a side screw facing surface.

FIG. 4 is a cross-sectional view illustrating a configuration of a pressure detection section.

FIG. 5 is a cross-sectional view of the pressure detection section illustrated in FIG. 4 taken along line V-V.

FIG. 6 is an enlarged side view of a portion A of the three dimensional molding device illustrated in FIG. 1.

FIG. 7 is an enlarged cross-sectional view of a portion A of the three dimensional molding device illustrated in FIG. 1.

FIG. 8 is a plan view of the configuration of the pressure detection section as viewed from below.

FIG. 9 is a perspective view illustrating a configuration of a pressure generating section.

FIG. 10 is a perspective view illustrating a configuration of a pressure generating section.

FIG. 11 is a perspective view illustrating a configuration of a main body section of a pressure generating section.

FIG. 12 is a flowchart illustrating a measurement method of the three dimensional molding device.

FIG. 13 is a perspective view illustrating a part of a measurement method of the three dimensional molding device.

FIG. 14 is a perspective view illustrating a part of a measurement method of the three dimensional molding device.

FIG. 15 is a graph illustrating a relationship between thrust and pressure.

### DESCRIPTION OF EMBODIMENTS

Hereinafter, a three dimensional molding device 100 and a measurement method of the three dimensional molding device 100 will be described with reference to the drawings. In the following drawings, three axes orthogonal to each other are described as an X axis, a Y axis, and a Z axis. A direction along the X axis is defined as an “X direction”, a direction along the Y axis is defined as a “Y direction”, a direction along the Z axis is defined as a “Z direction”, a direction of an arrow is defined as a +direction, and a direction opposite to the +direction is defined as a −direction. Note that viewing from the +Z direction or the −Z direction is also referred to as plan view or planar.

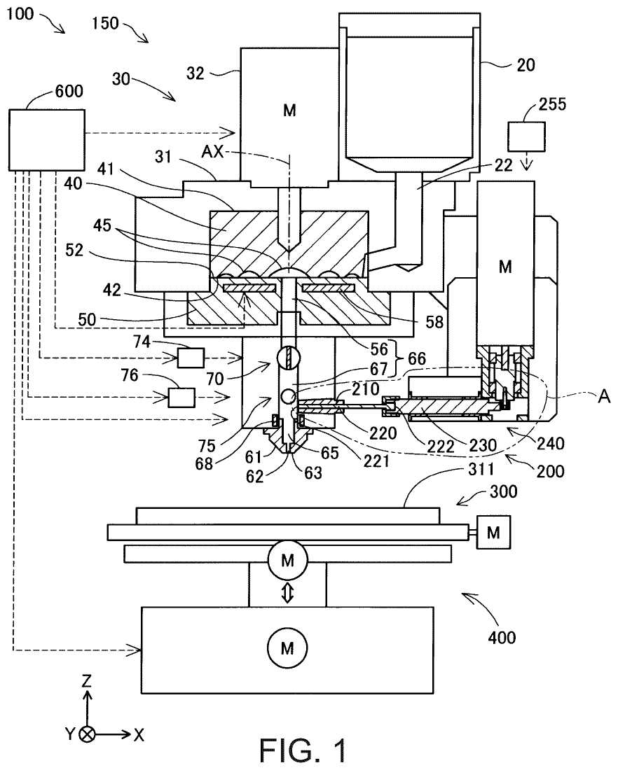

First, a configuration of a three dimensional molding device 100 will be described with reference to FIG. 1.

As illustrated in FIG. 1, the three dimensional molding device 100 includes a material delivery device 150, a stage 300, a position change section 400, and a control section 600.

The control section 600 controls the operation of the entire three dimensional molding device 100 to execute molding processing for molding a three dimensional molding object. The control section 600 is configured by a computer including one or a plurality of processors and a main storage device. The control section 600 exhibits various functions by the processor executing a program read into the main storage device.

Note that some of the functions of the control section 600 may be realized by a hardware circuit. In the molding process executed by the control section 600, the material delivery device 150 and the position change section 400 are controlled in accordance with the molding data of the three dimensional molding object.

Under the control of the control section 600, the material delivery device 150 delivers a plasticization material, which is obtained by melting a material in a solid state into a paste state, to the outside. The material delivery device 150 ejects the plasticization material onto a stage 300 for molding, which serves as a base for the three dimensional molding object.

The material delivery device 150 includes a material supply section 20 that is the supply source of the material before it is converted into plasticization material, a plasticizing section 30 that plasticizes the material by rotation of a screw 40 to generate the plasticization material, a flow path 66 through which the generated plasticization material flows, a nozzle 61 that communicates with the flow path 66 and that delivers the plasticization material to the outside, and a pressure detection section 200 that which is connected to the flow path 66 and that detects pressure of the plasticization material in the flow path 66. Further, the flow path 66 is provided with a delivery amount adjustment section 70 and is connected to a suction and discharge section 75.

The material supply section 20 stores the material in a state of pellets, powder, or the like. In the present embodiment, ABS resin formed in a pellet shape is used as the material. The material supply section 20 is configured by a hopper. A supply path 22 that connects the material supply section 20 and the plasticizing section 30 is provided below the material supply section 20. The material supply section 20 supplies the material to the plasticizing section 30 via the supply path 22.

The plasticizing section 30 includes a screw case 31, a drive motor 32, a screw 40, a barrel 50, and a plasticization heater 58. The plasticizing section 30 uses the rotation of the screw 40 to plasticize at least a part of the material supplied from the material supply section 20, and generates a pasty plasticization material having fluidity. The plasticizing section 30 supplies the generated plasticization material to the nozzle 61 via a flow path 66 provided between the screw 40 and the nozzle 61.

“Plasticization” is a concept including melting, and is a change from a solid to a state having fluidity. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point. The screw 40 is a so-called flat screw, and may be referred to as a “scroll”.

The screw case 31 is a housing for accommodating the screw 40. The barrel 50 is fixed to the lower surface of the screw case 31, and the screw 40 is accommodated in a space surrounded by the screw case 31 and the barrel 50. The screw 40 has a groove forming surface 42 in which grooves 45 are formed on a surface facing the barrel 50.

A drive motor 32 is fixed to the top surface of the screw case 31. The rotation shaft of the drive motor 32 is connected to the top surface 41 side of the screw 40. The drive motor 32 may not be directly connected to the screw 40, and for example, the screw 40 and the drive motor 32 may be connected via a speed reducer. The drive motor 32 is driven under the control of the control section 600.

The barrel 50 is disposed below the screw 40. The barrel 50 has a screw facing surface 52 facing the groove forming surface 42 of the screw 40. The barrel 50 is provided with a communication hole 56 on the central axis AX of the screw 40. The communication hole 56 forms a part of the flow path 66 described above.

More specifically, the flow path 66 is formed by the communication hole 56 and the supply flow path 67. The supply flow path 67 is a flow path that connects the communication hole 56 and the nozzle 61. The supply flow path 67 may not be provided, and the communication hole 56 and the nozzle 61 may be directly connected to each other.

The plasticization heater 58 is built into the barrel 50 at a position facing the grooves 45 of the screw 40. The plasticization heater 58 heats the material supplied between the screw 40 and the barrel 50. The temperature of the plasticization heater 58 is controlled by the control section 600.

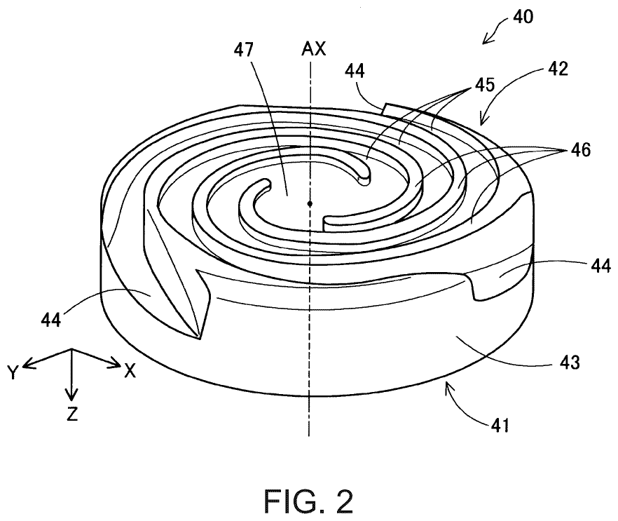

Next, the configuration of the screw 40 will be described with reference to FIG. 2.

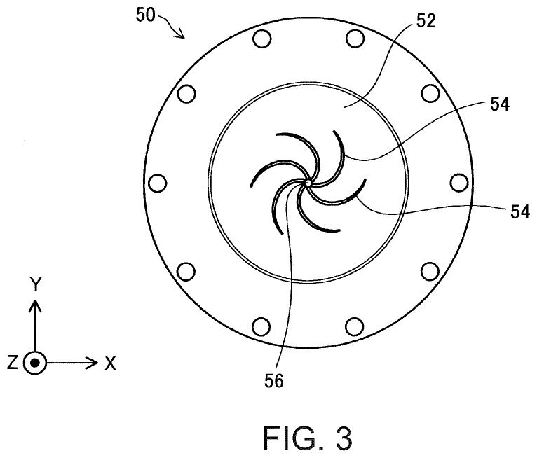

As illustrated in FIG. 2, the center section 47 of the groove forming surface 42 of the screw 40 is configured as a recess to which one end of each of the grooves 45 is connected. As illustrated in FIG. 3, the center section 47 faces the communication hole 56 of the barrel 50. The center section 47 intersects the central axis AX.

The grooves 45 constitute so-called scroll grooves. The grooves 45 extend in a spiral shape so as to draw an arc from the center section 47 toward the outer periphery of the screw 40. The groove forming surface 42 is provided with convex sections 46 that constitute side wall sections of the grooves 45 and that extend along each groove 45. The grooves 45 are continuous to the material inlet 44 formed in the side surface 43 of the screw 40.

The material inlet 44 is a portion that receives the material supplied via the supply path 22 of the material supply section 20. The material received by the material inlet 44 is fed between the screw 40 and the barrel 50.

As illustrated in FIG. 2, three grooves 45 are formed so as to be separated by the convex sections 46. The number of grooves 45 is not limited to three, and may be one or two or more. The grooves 45 are not limited to a vortex shape, but may be a spiral shape or an involute curve shape, or may be a shape extending so as to draw an arc from the center section 47 toward the outer periphery.

Next, the configuration of the barrel 50 on the screw facing surface 52 side will be described with reference to FIG. 3.

As illustrated in FIG. 3, a communication hole 56 is formed in the center of the screw facing surface 52. A plurality of guide grooves 54 are formed around the communication hole 56 in the screw facing surface 52.

Each of the guide grooves 54 has one end connected to the communication hole 56 and extends in a spiral shape from the communication hole 56 toward the outer periphery of the screw facing surface 52. Each of the guide grooves 54 has the function of guiding the plasticization material to the communication hole 56. Note that one end of the guide grooves 54 may not be connected to the communication hole 56. Also, the barrel 50 may not be formed with the guide grooves 54.

As illustrated in FIG. 1, the plasticizing section 30 heats the material supplied between the screw 40 and the barrel 50 while transporting the material toward the flow path 66 by the screw 40, the barrel 50, and the plasticization heater 58 described above to generate the plasticized material, and supplies the generated plasticization material to the nozzle 61 via the flow path 66.

The nozzle 61 includes a nozzle flow path 65 and a tip end surface 63 provided with a nozzle opening 62. The nozzle flow path 65 is a flow path of the plasticization material formed in the nozzle 61, and connects with the flow path 66 described above.

Specifically, the nozzle flow path 65 is connected to the supply flow path 67 described above. The tip end surface 63 is a surface constituting a tip portion of the nozzle 61 protruding in the −Z direction toward the molding surface 311. The nozzle opening 62 is a portion that is provided at the end portion of the nozzle flow path 65 on a side connecting to atmosphere and that has a reduced flow path cross section of the nozzle flow path 65. The plasticization material generated by the plasticizing section 30 is supplied to the nozzle 61 via the flow path 66 and is ejected from the nozzle opening 62 via the nozzle flow path 65.

A nozzle heater 68 is provided around the nozzle flow path 65. The nozzle heater 68 heats the nozzle 61 and heats the plasticization material in the nozzle flow path 65 under the control of the control section 600.

The control section 600 can adjust the fluidity of the plasticization material in the nozzle flow path 65 by controlling the output of the nozzle heater 68. The set temperature of the nozzle heater 68 is set to a temperature higher than the set temperature of the plasticization heater 58 of the plasticizing section 30 described above.

The delivery amount adjustment section 70 adjusts the flow rate of the plasticization material delivered from the nozzle opening 62. The flow rate of the plasticization material delivered from the nozzle opening 62 to the outside may be referred to as a delivery amount. The delivery amount adjustment section 70 is configured by a butterfly valve that changes the opening degree of the flow path 66 by rotating in the flow path 66, and is disposed in the supply flow path 67 of the flow path 66.

The delivery amount adjustment section 70 is driven by a first drive section 74 configured by a stepping motor or the like under the control of the control section 600. The control section 600 adjusts the opening degree of the flow path 66 by controlling the rotation angle of the butterfly valve using the first drive section 74.

Accordingly, the control section 600 can adjust the flow rate of the plasticization material flowing from the plasticizing section 30 to the nozzle 61 and adjust the delivery amount. The delivery amount adjustment section 70 can also set the delivery amount to 0 by setting the opening degree of the flow path 66 to 0. That is, the delivery amount adjustment section 70 adjusts the delivery amount and controls the on/off of delivery of the plasticization material.

The suction and discharge section 75 is connected between the delivery amount adjustment section 70 and the nozzle opening 62 in the flow path 66. The suction and discharge section 75 performs a suction operation of sucking the plasticization material in the flow path 66 and a discharge operation of pushing out the sucked plasticization material toward the nozzle opening 62.

The suction and discharge section 75 is configured by a plunger. The suction and discharge section 75 retracts the plunger in a direction away from the flow path 66 in the suction operation described above, and advances the plunger in a direction approaching the flow path 66 in the discharge operation. The suction and discharge section 75 is driven by the second drive section 76 under the control of the control section 600.

The second drive section 76 is constituted by, for example, a stepping motor and a rack and pinion mechanism that converts the rotational force of the stepping motor into the translational movement of the plunger.

The control section 600 suppresses a tailing phenomenon in which the plasticization material hangs down like strings from the nozzle opening 62 by executing the suction operation by the suction and discharge section 75 when stopping the delivery of the plasticization material from the nozzle 61.

In this case, the control section 600 can more effectively suppress the tailing phenomenon by executing the suction operation after the opening degree of the flow path 66 is set to 0 by the delivery amount adjustment section 70. The suction and discharge section 75 performs a discharge operation by the suction and discharge section 75 when delivery of the plasticization material from the nozzle 61 is started or restarted, thereby improving the responsiveness of feed of the plasticized material from the nozzle 61.

In this case, the control section 600 executes the suction operation before the opening degree of the flow path 66 is set to be larger than 0 by the delivery amount adjustment section 70, and thus it is possible to further improve the responsiveness of the delivery of the plasticization material.

The stage 300 is disposed at a position facing the tip end surface 63 of the nozzle 61. The three dimensional molding device 100 delivers the plasticization material from the nozzle 61 toward the molding surface 311 of the stage 300 and stacks layers of the plasticization material to mold a three dimensional molding object.

The position change section 400 changes the relative position between the nozzle 61 and the stage 300 by changing the relative position between the material delivery device 150 and the stage 300. The position change section 400 moves the stage 300 with respect to the material delivery device 150.

Note that the change in the relative position of the material delivery device 150 or the nozzle 61 with respect to the stage 300 may be simply referred to as movement of the material delivery device 150 or the nozzle 61. That is, for example, movement of the stage 300 in the +X direction can be called movement of the material delivery device 150 or of the nozzle 61 in the −X direction.

The position change section 400 is configured by a three axis positioner that moves the stage 300 in three axial directions of the X, Y, and Z directions by driving forces of three motors. Each motor is driven under the control of the control section 600. The position change section 400 may be configured to move the material delivery device 150 without moving the stage 300, instead of moving the stage 300. The position change section 400 may be configured to move both the stage 300 and the material delivery device 150.

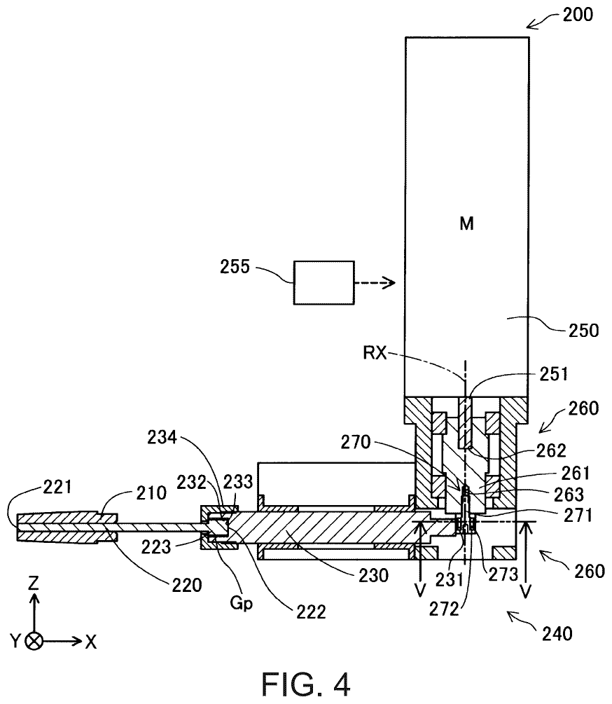

Next, the configuration of the pressure detection section 200 will be described with reference to FIG. 4.

The pressure detection section 200 includes a cylinder 210 connected to the flow path 66, a plunger pin 220 inserted into the cylinder 210, a transmission member 230 connected to the plunger pin 220, and a measurement section 240 that measures the pressure of the plasticization material in the flow path 66 via the plunger pin 220 and the transmission member 230.

The cylinder 210 has a tubular shape with its axial direction as a longitudinal direction. As illustrated in FIGS. 1 and 4, the cylinder 210 is disposed such that the longitudinal direction thereof is along the X direction. As illustrated in FIG. 1, the end portion of the cylinder 210 in the −X direction is open in the −X direction toward the flow path 66. The end portion of the cylinder 210 in the +X direction is located in the +X direction of the flow path 66. The flow path 66 communicates with the outside of the flow path 66 in the X direction via the cylinder 210.

The cylinder 210 is connected to the flow path 66 (see FIG. 1) downstream of the delivery amount adjustment section 70. The cylinder 210 is connected to the flow path 66 downstream of the suction and discharge section 75. The cylinder 210 may be connected to, for example, the upstream side of the suction and discharge section 75 in the flow path 66.

The plunger pin 220 has a shaft shape with its axial direction as a longitudinal direction. The plunger pin 220 is formed of tool steel. As illustrated in FIGS. 1 and 4, the plunger pin 220 is inserted into the cylinder 210 such that the longitudinal direction thereof is along the X direction.

The plunger pin 220 has a pin end face 221 and a transmission section 222 that is farther in the X direction from the flow path 66 than the pin end face 221. The pin end face 221 is an end face of the plunger pin 220 in the −X direction. As illustrated in FIG. 1, the pin end face 221 faces the flow path 66 in the cylinder 210.

The transmission section 222 is an end face on the opposite side of the plunger pin 220 than the pin end face 221 in the longitudinal direction, and is an end face in the +X direction of the plunger pin 220. The plunger pin 220 has a connection section 223 at the end portion in the +X direction that has a diameter larger than that of the other portions of the plunger pin 220 in the X direction. The transmission section 222 is the +X direction end face of the connection section 223. As illustrated in FIGS. 1 and 4, the transmission section 222 is in contact with the transmission member 230 in the X direction at a position in the +X direction of the cylinder 210.

The interval between the side surface of the plunger pin 220 and the inner side surface of the cylinder 210 is, for example, 50 μm or less from the viewpoint of suppressing leakage of the plasticization material in the flow path 66 to the outside through gaps between the plunger pin 220 and the cylinder 210.

As illustrated in FIGS. 1 and 4, the transmission member 230 is disposed between the plunger pin 220 and the measurement section 240 in the X direction. The transmission member 230 is formed of stainless steel. An end face 231 of the transmission member 230 in the +X direction is in contact with the measurement section 240.

As illustrated in FIG. 4, a concave section 232 that opens in the −X direction is formed in the end portion of the transmission member 230 in the −X direction. The +X direction tip portion of the plunger pin 220 is inserted into the opening of the concave section 232. In the opening of the concave section 232, the transmission section 222 of the plunger pin 220 is in contact with the bottom section 233 of the concave section 232 in the X direction.

The plunger pin 220 and the transmission member 230 are coupled by a joint 234 that covers a side surface of the −X direction end portion of the transmission member 230. The joint 234 has a shape that engages with a surface of the connection section 223 of the plunger pin 220 in the −X direction, and restricts the movement of the plunger pin 220 in the −X direction with respect to the transmission member 230.

A gap Gp is formed between the side surface of the connection section 223 of the plunger pin 220 and the inner side surface of the concave section 232. Therefore, the plunger pin 220 contacts the transmission member 230 in the X direction, but does not contact in the Y direction or the Z direction. A gap is also formed between the side surface of the plunger pin 220 and the connection section 223.

The plunger pin 220 transmits pressure of the plasticization material in the flow path 66 to the measurement section 240. More specifically, the plunger pin 220 receives a force in the +X direction on the pin end face 221 due to pressure of the plasticization material in the flow path 66, and transmits the force to the transmission member 230 via the transmission section 222. The force transmitted to the transmission member 230 via the transmission section 222 is transmitted to the measurement section 240 via the end face 231 of the transmission member 230. Hereinafter, the force transmitted to the measurement section 240 via the transmission section 222 in this manner may be referred to as a detection force.

The measurement section 240 includes a motor 250 having an output shaft 251, and a torque member 260 connected to the output shaft 251.

The motor 250 is disposed with the output shaft 251 facing the −Z direction so that the output shaft 251 is along the Z direction, which is orthogonal to the longitudinal direction of the plunger pin 220. The motor 250 is configured by a servo motor. The measurement section 240 includes a controller 255 for servo-controlling the motor 250. The driving of the motor 250 is controlled by the control section 600 via the controller 255.

The controller 255 performs position holding control for performing feedback control so as to hold the rotational position of the output shaft 251. More specifically, when torque is applied to the output shaft 251 from the outside in a state where the driving of the motor 250 is stopped, the controller 255 regulates the change in the rotational position of the output shaft 251 by generating torque in the opposite direction to the torque in the output shaft 251.

When the rotational position of the output shaft 251 is changed by torque applied from the outside, the rotational position of the output shaft 251 is returned to the original position by generating torque in the opposite direction to the torque in the output shaft 251 in the same manner. Such position holding control is sometimes called a servo lock. Hereinafter, the torque for holding the rotational position of the output shaft 251 in the position holding control may be referred to as position holding torque.

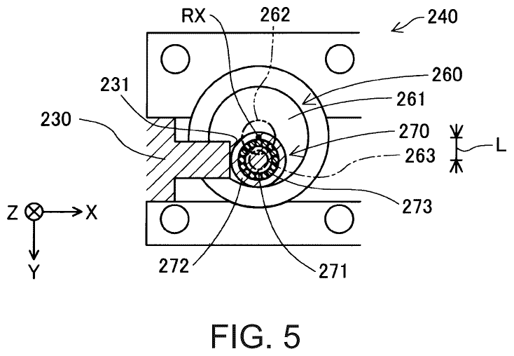

Next, a pressure detection method will be described with reference to FIG. 5.

As illustrated in FIG. 5, the torque member 260 has a connecting section 261 and a force receiving section 270.

The connecting section 261 is a substantially columnar member disposed along the Z direction. The connecting section 261 is formed with a connection hole 262 for connecting the output shaft 251 of the motor 250 and a fixing hole 263 for fixing the force receiving section 270.

The connection hole 262 is open in the +Z direction at the end portion of the connecting section 261 in the +Z direction (see FIG. 4). The fixing hole 263 is open in the −Z direction at the end portion of the connecting section 261 in the −Z direction. In FIG. 5, the position of the connection hole 262 in the X direction and the Y direction is indicated in two dot chain line, and similarly, the position of the fixing hole 263 is indicated in single dot chain line.

The connection hole 262 is formed in the center of the connecting section 261 when viewed along the Z direction. The fixing hole 263 is formed at a position shifted from the center of the connecting section 261 when viewed along the Z direction. Therefore, the fixing hole 263 is located at a position shifted from the rotation axis RX of the output shaft 251 when viewed along the Z direction.

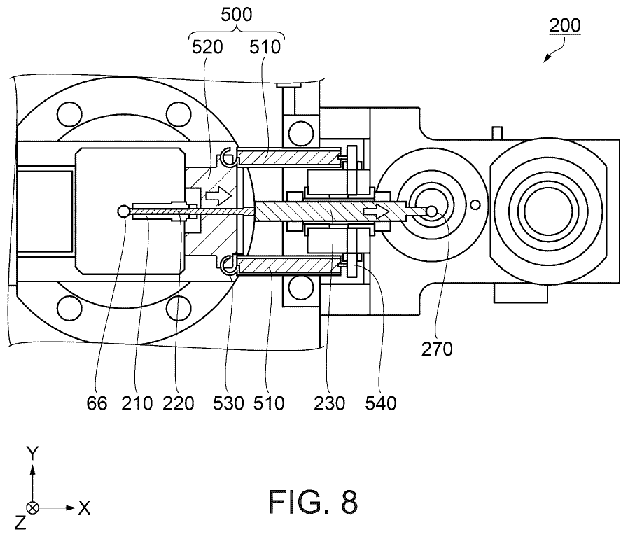

As illustrated in FIGS. 5 and 8, the force receiving section 270 is formed by a cam follower and includes a shaft 271 and an outer ring 272. The end portion of the shaft 271 in the +Z direction is inserted into the fixing hole 263 of the connecting section 261 described above. The outer ring 272 is supported by a bearing 273 fixed to a side surface of the shaft 271 so as to be rotatable on the shaft 271. The outer ring 272 and the bearing 273 are disposed in the −Z direction of the connecting section 261.

The fixing hole 263 is formed at a position shifted from the rotation axis RX. Therefore, as illustrated in FIG. 5, the force receiving section 270 is disposed at a position shifted from the rotation axis RX when viewed along the Z direction. More specifically, the force receiving section 270 is disposed at a position shifted from the rotation axis RX in the +Y direction by a distance L when viewed along the Z direction.

The torque member 260 receives the detection force described above and applies torque by the detection force to the output shaft 251. The torque member 260 generates a rotational force for rotating the connecting section 261 connected to the output shaft 251 by receiving the detection force at the outer ring 272 of the force receiving section 270, and applies torque generated by the rotational force to the output shaft 251. Hereinafter, the torque generated by the detection force applied to the output shaft 251 may be referred to as detection torque.

The measurement section 240 detects the pressure of the plasticization material in the flow path 66 based on the current value or the voltage value of the motor 250 generated by the detection torque applied to the output shaft 251. More specifically, the measurement section 240 detects a voltage value for generating the position holding torque corresponding to the detection torque in a state where the position holding control is performed by the controller 255 described above, and detects the pressure of the plasticization material in the flow path 66 based on the detected voltage value. Accordingly, the measurement section 240 can detect the pressure while regulating the movement of the plunger pin 220 and the transmission member 230 in the +X direction.

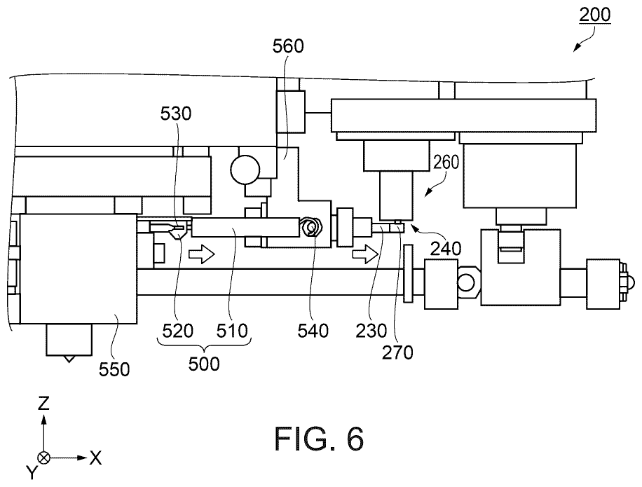

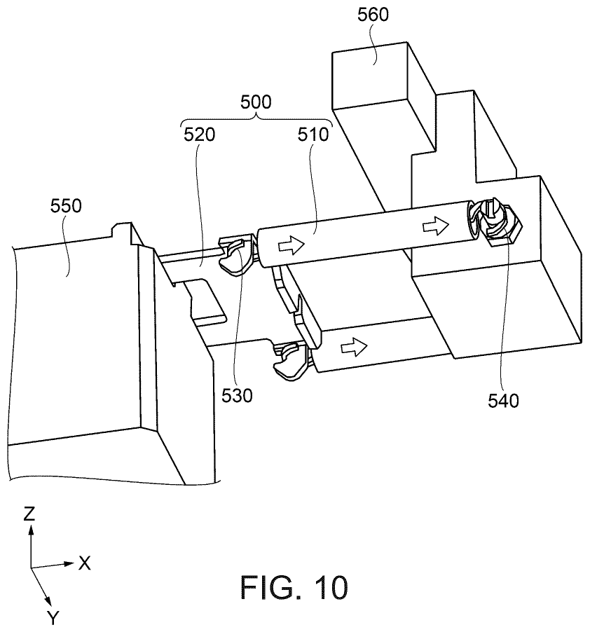

Next, specific configurations of the pressure detection section 200 and the pressure generating section 500 will be described with reference to FIGS. 6 to 11.

As illustrated in FIGS. 6 to 8, the pressure detection section 200 detects the pressure of at least a portion of the flow path 66 (see FIG. 1) as described above. The pressure generating section 500 (see FIG. 6) is connected to the pressure detection section 200 and generates pressure.

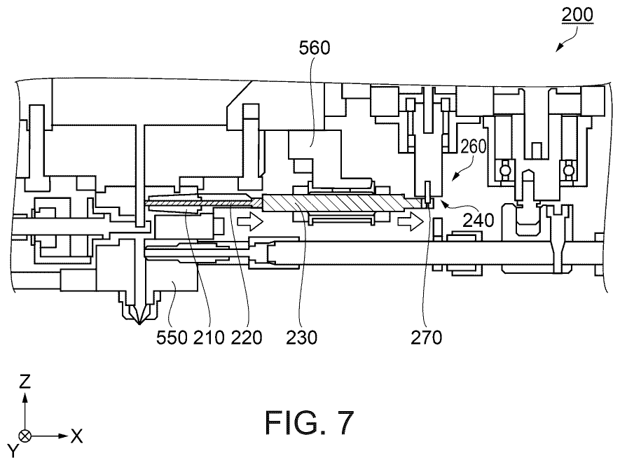

Specifically, the pressure detection section 200 includes the cylinder 210 (see FIG. 7) connected to the flow path 66, the plunger pin 220 disposed to be slidable in the cylinder 210, the transmission member 230 connected to the plunger pin 220 on the side opposite to the flow path 66, the measurement section 240 connected via the transmission member 230 and configured to measure the pressure received by the plunger pin 220 from the plasticization material, and a housing 550 configured to hold the cylinder 210.

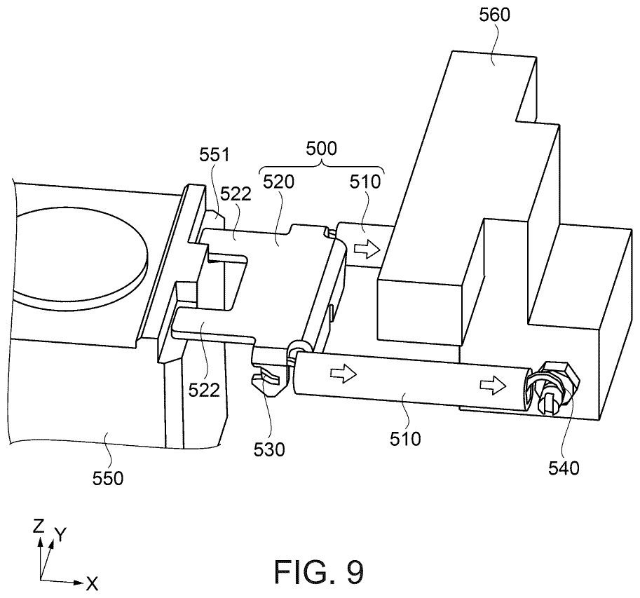

As illustrated in FIGS. 9, 10, and 11, the pressure generating section 500 includes a spring 510 and a main body section 520 including a first engagement section 530 for connecting to one end of the spring 510. The pressure detection section 200 includes a second engagement section 540 for connecting to the other end of the spring 510.

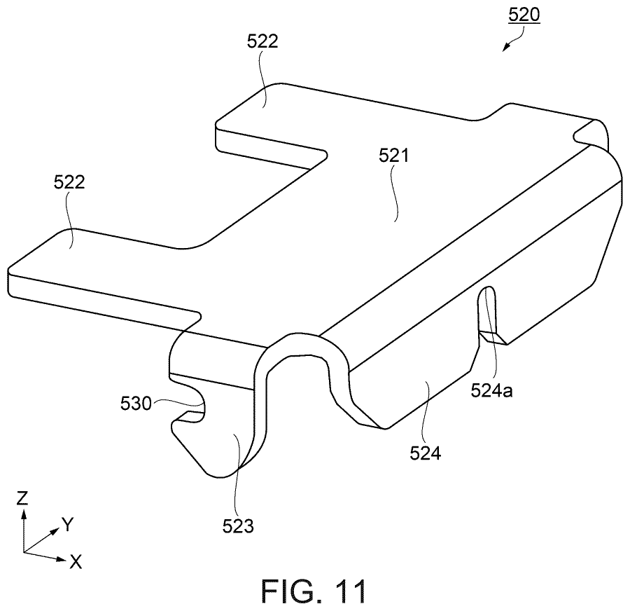

As illustrated in FIG. 11, the main body section 520 includes a plate section 521 extending in a direction along a molding surface 311 (refer to FIG. 1) on which the plasticization material is ejected and on which the three dimensional molding object is molded, and two support sections 522 protruding along the plate section 521.

Specifically, the main body section 520 has a first portion 523 connected substantially at a right angle to the extending direction of the plate section 521. The first portion 523 is bent along the X direction. The first portion 523 is provided with a first engagement section 530 to which one end of the spring 510 is connected. Specifically, the first engagement section 530 is a groove for hooking the spring 510. The main body section 520 includes two first portions 523 each having a first engagement section 530.

As illustrated in FIG. 9, the two support sections 522 are disposed in contact with the upper section 551 of the housing 550. Therefore, when the spring 510 is connected to the first engagement section 530 and the second engagement section 540, the support sections 522 are supported in contact with the upper section 551 of the housing 550, and thus the spring 510 can be stably connected.

The main body section 520 has a second portion 524 connected substantially at right angles to the extending direction of the plate section 521. The second portion 524 is bent along the Y direction. The second portion 524 is provided with a groove section 524a that engages with the plunger pin 220.

In this manner, by replacing the pressure of the plasticization material with the spring 510, it is possible to detect the pressure of the plasticization material based on the current value or the voltage value of the motor 250 of the measurement section 240 without ejecting the plasticization material.

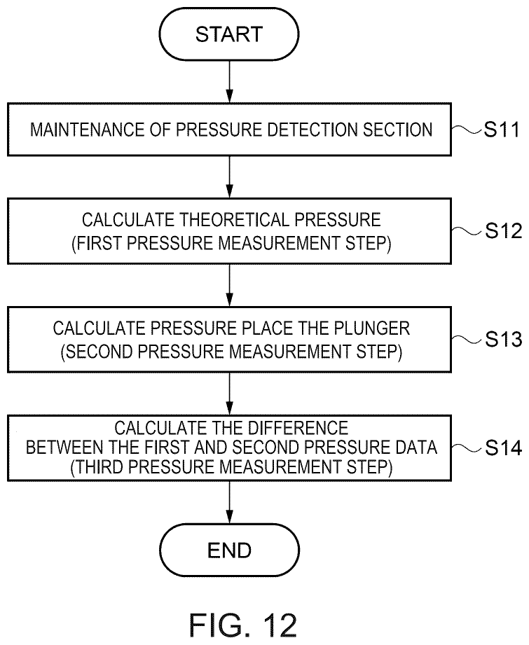

Next, a measurement method of the three dimensional molding device 100 will be described with reference to FIGS. 12 to 15.

As illustrated in FIG. 12, first, in step S11, cleaning, that is, maintenance, of the pressure detection section 200 is performed. Maintenance is performed because, when the three dimensional molding device 100 is used, the plasticization material becomes fixed and operation of the plunger pin 220 sliding in the cylinder 210 deteriorates.

In step S12 (first pressure measurement step), the theoretical pressure is calculated. The pressure of the theoretical value is referred to as first pressure data. Here, the pressure applied to the plasticization material is replaced with the spring 510 constituting the pressure generating section 500, and the pressure of the plasticization material is obtained by calculation from the spring constant.

In step S13 (second pressure measurement step), calculating the pressure of the plasticization material using the plunger pin 220. Here, the pressure applied to the plasticization material is replaced with the spring 510 used in the step S12, and thus obtaining a pseudo pressure applied to the plasticization material. That is, without ejecting the plasticization material, the pressure generated by biasing the plunger pin 220 in the cylinder 210 is obtained using the spring 510. The pressure measured in this step is referred to as second pressure data.

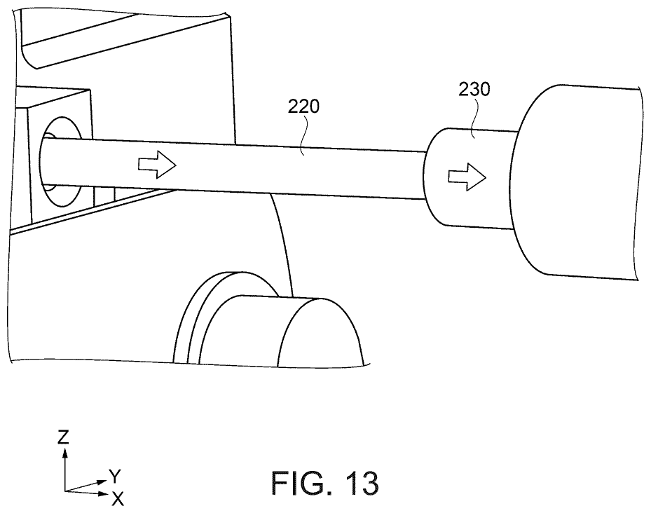

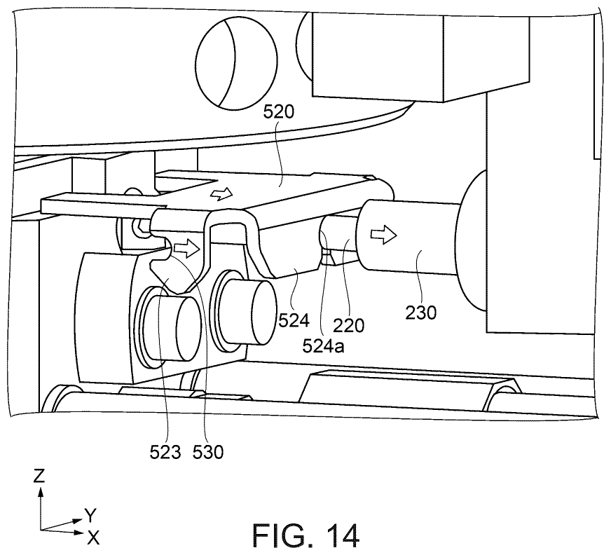

To be more specific, as illustrated in FIGS. 13 and 14, the pressure can be obtained in the measurement section 240 by fitting the plunger pin 220 into the groove section 524a of the main body section 520, hooking one end of the spring 510 on the main body section 520, and hooking the other end of the spring 510 on the housing 560. In FIG. 14, the spring 510 is not illustrated. When the spring 510 is connected to the first engagement section 530 and the second engagement section 540, the two support sections 522 are disposed in contact with the upper section 551 of the housing 550.

In step S14 (third pressure measurement step), the difference between the first pressure data and the second pressure data is measured. Specifically, a difference is measured between first pressure data that was measured in the first pressure measurement step, that is, the theoretical value of pressure obtained from the spring constant or the like without using the plunger pin 220, and second pressure data that was measured in the second pressure measurement step, that is, the actual measurement value measured using the plunger pin 220 without delivering the plasticization material. This makes it possible to check whether or not the measurement section 240 can accurately measure the pressure. That is, it is possible to determine whether the pressure detection section 200 is in a state where the pressure detection section 120 can properly perform measurement.

For example, when there is no difference between the first pressure data and the second pressure data, it can be determined that maintenance has been properly performed. On the other hand, when there is a difference between the first pressure data and the second pressure data, it can be determined that maintenance has not been performed properly, and the maintenance is to be performed again.

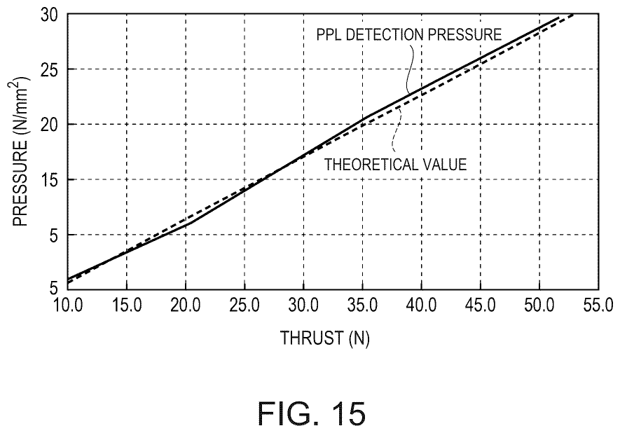

Note that FIG. 15 shows a graph illustrating the relationship between the thrust (N) and the pressure (N/mm²) by comparing the first pressure data, which is a theoretical value, and the PPL detected pressure, that is, the second pressure data, which is an actual measurement value.

In step S11, when maintenance is properly performed, it is understood that the first pressure data and the second pressure data show substantially the same value as illustrated in FIG. 15. If the value is significantly different from the graph, it can be determined that the maintenance has not been properly performed.

As described above, it is desirable to include a cleaning step of cleaning the pressure detection section 200 before the second pressure measurement step. According to this method, since the second pressure measurement step is performed after cleaning of the pressure detection section 200, specifically, after cleaning of the cylinder 210 and the plunger pin 220 to which the plasticization material is likely to adhere, it is possible to determine whether or not the maintenance has been properly performed.

In the first pressure measurement step and the second pressure measurement step, since the pressure is generated by the spring 510 being connected to the first engagement section 530 and the second engagement section 540, the pressure can be generated with a relatively simple configuration.

Since the plunger pin 220 is fitted into the groove section 524a, pressure can be generated with a relatively simple configuration.

As described above, the measurement method of the three dimensional molding device 100, which includes the flow path 66 through which plasticization material plasticized by heat flows; the nozzle 61 that communicates with the flow path 66 and that is configured to deliver the plasticization material to the outside; the pressure detection section 200 that detects pressure of at least a part of the flow path 66; and the pressure generating section 500 that is connected to the pressure detection section 200 and that is configured to generate pressure, wherein the pressure detection section 200 includes the cylinder 210 connected to the flow path 66, the plunger pin 220 slidably disposed in the cylinder 210, the transmission member 230 connected to the plunger pin 220 on the side opposite to the flow path 66, the measurement section 240 that is connected via the transmission member 230 and that is configured to measure pressure received by the plunger pin 220 from the plasticization material, is a measurement method that includes the first pressure measurement step of measuring the pressure of the pressure generating section 500 as first pressure data; the second pressure measurement step of the measurement section 240 measuring, as second pressure data, the pressure generated by the pressure generating section 500 biasing the plunger pin 220; and the third pressure measurement step of measuring the difference between the first pressure data and the second pressure data.

According to this method, since the difference is measured between the first pressure data measured in the first pressure measurement step, that is, the theoretical value of the pressure obtained from the spring constant or the like without using the plunger pin 220, and the second pressure data measured in the second pressure measurement step, that is, the actual measurement value measured using the plunger pin 220 without delivering the plasticization material, it is possible to confirm whether or not the measurement section 240 can accurately measure the pressure. Therefore, it is possible to determine whether the pressure detection section 200 is in a state where the pressure detection section 120 can properly perform measurement.

Since the first pressure data of the theoretical value and the second pressure data of the actual measurement value are equivalent numerical values, it can be determined that there is no fixation due to the plasticization material and there is no mechanical loss in the plunger pin 220 in the cylinder 210.

In the measurement method of the three dimensional molding device 100 of the present embodiment, it is desirable to include a cleaning step of cleaning the pressure detection section 200 before the second pressure measurement step.

According to this method, since the second pressure measurement step is performed after cleaning of the pressure detection section 200, specifically, after cleaning of the cylinder 210 and the plunger pin 220 to which the plasticization material is likely to adhere, it is possible to determine whether or not the maintenance has been properly performed.

In the measurement method of the three dimensional molding device 100 of the present embodiment, it is desirable that the pressure generating section 500 includes the spring 510 and the main body section 520 including the first engagement section 530 for connecting to one end of the spring 510, the pressure detection section 200 includes the second engagement section 540 for connecting to the other end of the spring 510 at the opposite side than the one end, and in the second pressure measurement step, the spring 510 is connected to the first engagement section 530 and the second engagement section 540 to generate the pressure.

According to this method, since the spring 510 is used, the pressure can be generated with a relatively simple configuration.

In the measurement method of the three dimensional molding device 100 of the present embodiment, it is desirable that the main body section 520 includes the plate section 521 extending in the direction along the molding surface 311 on which the plasticization material is ejected and on which the three dimensional molding object is shaped, and the support sections 522 protruding along the plate section 521 and the pressure detection section 200 includes the housing 550 that holds the cylinder 210, and in the second pressure measurement step, the support sections 522 are in contact with the upper section 551 of the housing 550 when the spring 510 is connected to the first engagement section 530 and the second engagement section 540.

According to this method, since the support sections 522 is in contact with the upper section 551 of the housing 550, the support sections 522 can be supported, and the spring 510 can be stably connected.

In the measurement method of the three dimensional molding device 100 of the present embodiment, it is desirable that the first engagement section 530 is formed in the first portion 523 connected substantially at a right angle to the extending direction of the plate section 521 and in the second pressure measurement step, the spring 510 is connected to the first engagement section 530 and the second engagement section 540 to generate the pressure.

According to this method, since the first engagement section 530 is formed in the portion that is bent at a right angle with respect to the plate section 521, the spring 510 is easily set to the first engagement section 530 and the second engagement section 540, in other words, it is easily hooked.

In the measurement method of the three dimensional molding device 100 of the present embodiment, it is desirable that the main body section 520 has the second portion 524 that is in contact with the plunger pin 220 and that is connected substantially at a right angle to the extending direction of the plate section 521, the second portion 524 is provided with the groove section 524a that fits with the plunger pin 220, in the second pressure measurement step, the pressure is generated by fixing the groove section 524a to the plunger pin 220.

According to this method, since the pressure generating device is configured by fitting the plunger pin 220 into the groove section 524a, the pressure can be generated with a relatively simple configuration.

Hereinafter, a modification of the above-described embodiment will be described.

As described above, the spring 510 is not limited to one type, and a plurality of springs 510 having different spring constants may be used.

What is claimed is:

1. A measurement method of three dimensional molding device, the three dimensional molding device including
a flow path through which a plasticization material plasticized by heat flows;
a nozzle communicating with the flow path and configured to deliver the plasticization material outside;
a pressure detection section that detects pressure of at least a part of the flow path; and
a pressure generating section connected to the pressure detection section and configured to generate pressure, wherein
the pressure detection section includes
a cylinder connected to the flow path,
a plunger pin slidably disposed in the cylinder,
a transmission member connected to an opposite side of the plunger pin than the flow path, and
a measuring section that is connected via the transmission member and measures a pressure received by the plunger pin from the plasticization material,
the method comprising:
a first pressure measurement step of measuring pressure of the pressure generating section as first pressure data;
a second pressure measurement step of the measuring section measuring, as second pressure data, pressure generated by the pressure generating section biasing the plunger pin; and
a third pressure measurement step of measuring a difference between the first pressure data and the second pressure data.

2. The measurement method of three dimensional molding device according to claim 1, further comprising:
a cleaning step of cleaning the pressure detection section before the second pressure measurement step.

3. The method of measuring three dimensional molding device according to claim 1, wherein
the pressure generating section includes a spring and a main body section that includes a first engagement section configured to connect to one end of the spring,
the pressure detection section includes a second engagement section configured to connect to an other end that is at an opposite side of the spring than the one end, and
in the second pressure measurement step, pressure is generated by the spring being connected to the first engagement section and to the second engagement section.

4. The measurement method of three dimensional molding device according to claim 3, wherein
the main body section includes a plate section extending in a direction along a molding surface on which the plasticization material is ejected to mold a three dimensional molding object, and a support section protruding along the plate section,
the pressure detection section includes a housing that holds the cylinder, and
in the second pressure measurement step, the support section is in contact with an upper section of the housing when the spring is connected to the first engagement section and the second engagement section.

5. The measurement method of three dimensional molding device according to claim 4, wherein
the first engagement section is formed in a first portion connected substantially at a right angle to an extending direction of the plate section and
in the second pressure measurement step, pressure is generated by the spring being connected to the first engagement section and to the second engagement section.

6. The measurement method of three dimensional molding device according to claim 5, wherein
the main body section has a second portion that is in contact with the plunger pin and that is connected substantially at a right angle to an extending direction of the plate section,
the second portion is provided with a groove section into which the plunger pin is fitted, and
in the second pressure measurement step, the pressure is generated by the groove section being fixed to the plunger pin.
